(19) United States
(12) Patent Application Publication
(10) Pub. No.: US 2014/0003293 A1
(43) Pub. Date: Jan. 2, 2014

(54) ENABLING DIRECT LINKS BETWEEN COMPUTING DEVICES ON AN EXTENDED SERVICE SET

(71) Applicants: Daniel R. Borges, San Francisco, CA (US); Birju N. Shah, Redwood City, CA (US); Christopher B. Zimmermann, San Jose, CA (US); Christiaan A. Hartman, San Jose, CA (US)

(72) Inventors: Daniel R. Borges, San Francisco, CA (US); Birju N. Shah, Redwood City, CA (US); Christopher B. Zimmermann, San Jose, CA (US); Christiaan A. Hartman, San Jose, CA (US)

(73) Assignee: APPLE INC., Cupertino, CA (US)

(21) Appl. No.: 13/536,801

(22) Filed: Jun. 28, 2012

(51) Int. Cl. H04W 84/18

(52) U.S. Cl. 370/255

(57) ABSTRACT

The disclosed embodiments provide a system that facilitates communication between a first computing device and a second computing device connected to the first computing device through an extended service set (ESS) of a wireless local area network (WLAN). During operation, the system obtains, on the first computing device, connection information associated with the second computing device. Next, the system uses the connection information to move the first computing device from a first basic service set (BSS) associated with the first computing device to a second BSS associated with the second computing device. After the first computing device is connected to the second BSS, the system establishes a direct link between the first computing device and the second computing device, wherein the direct link facilitates subsequent communication between the first and second computing devices.

### BACKGROUND

1. Field

The disclosed embodiments relate to wireless networks. More specifically, the disclosed embodiments relate to techniques for enabling direct links between computing devices on an Extended Service Set (ESS) of a wireless local area network (WLAN).

2. Related Art

Recent improvements in computing power and wireless networking technology have significantly increased the capabilities of portable computing devices. For example, laptop computers, tablet computers, portable media players, smartphones, and/or other modern portable computing devices are typically equipped with WiFi capabilities that allow the portable computing devices to stream audio and/or video, share desktops and/or user interfaces (UIs), and/or transfer files wirelessly among one another.

However, conventional wireless networking technology may require the use of preexisting access points, cellular radio towers, and/or other structured networks to connect portable computing devices to each other and/or the Internet. As a result, network traffic between two portable computing devices may be limited by the availability, bandwidth, and/or capabilities of structured network components used to transmit the network traffic.

On the other hand, modern portable computing devices may be capable of forming wireless ad hoc networks that bypass the use of access points, cellular towers, and/or structured networks to transmit network traffic among nodes of the wireless ad hoc networks. Instead, the portable computing devices may use the wireless ad hoc networks to communicate directly with one another, thereby increasing throughput and/or removing limitations associated with transmitting data through the access points and/or structured networks. Consequently, communication among portable computing devices may be facilitated by mechanisms for enabling the creation and use of wireless ad hoc networks by the portable computing devices.

### SUMMARY

The disclosed embodiments provide a system that facilitates communication between a first computing device and a second computing device connected to the first computing device through an extended service set (ESS) of a wireless local area network (WLAN). During operation, the system obtains, on the first computing device, connection information associated with the second computing device. Next, the system uses the connection information to move the first computing device from a first basic service set (BSS) associated with the first computing device to a second BSS associated with the second computing device. After the first computing device is connected to the second BSS, the system establishes a direct link between the first computing device and the second computing device, wherein the direct link facilitates subsequent communication between the first and second computing devices.

In some embodiments, if network traffic over the direct link falls below a pre-specified threshold, the system terminates the direct link. Next, if the first BSS is associated with a more robust connection than the second BSS, the system moves the first computing device from the second BSS back to the first BSS.

In some embodiments, obtaining the connection information associated with the second computing device involves transmitting one or more requests associated with the direct link from the first computing device to the second computing device, and obtaining one or more responses to the one or more requests from the second computing device, wherein the one or more responses comprise the connection information.

In some embodiments, the one or more requests include at least one of a discovery request and a first setup request for the direct link. The first setup request may be made by the first computing device on the first BSS and be associated with a negative response from the second computing device. The first setup request and the negative response may also form a handshake associated with establishing the direct link on the second BSS. The handshake may prevent the first and second computing devices from subsequently failing to establish the direct link by continually roaming to one another's BSSes.

In some embodiments, establishing the direct link between the first computing device and the second computing device involves transmitting a second setup request for the direct link from the first computing device to the second computing device, and receiving a positive response to the second setup request from the second computing device.

In some embodiments, the connection information includes at least one of a direct link status, an extended service set identifier (ESSID), a basic service set identifier (BSSID), a current operating channel, supported bands, supported channels, a signal strength, and a security mode.

In some embodiments, the direct link is not initiated if the signal strength indicates a no signal or a weak signal between the first and second computing devices, or no signal or a weak signal between the first computing device and the second BSS.

### BRIEF DESCRIPTION OF THE FIGURES

FIG. 1 shows a schematic of a system in accordance with the disclosed embodiments.

FIG. 2 shows a system for facilitating communication between a set of computing devices connected to one another through a distribution system of a wireless local area network (WLAN).

FIG. 3 shows the exemplary operation of two computing devices on an ESS of a WLAN in accordance with the disclosed embodiments.

FIG. 4 shows a flowchart illustrating the process of facilitating communication between a first computing device and a second computing device connected to the first computing device through an ESS of a WLAN in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

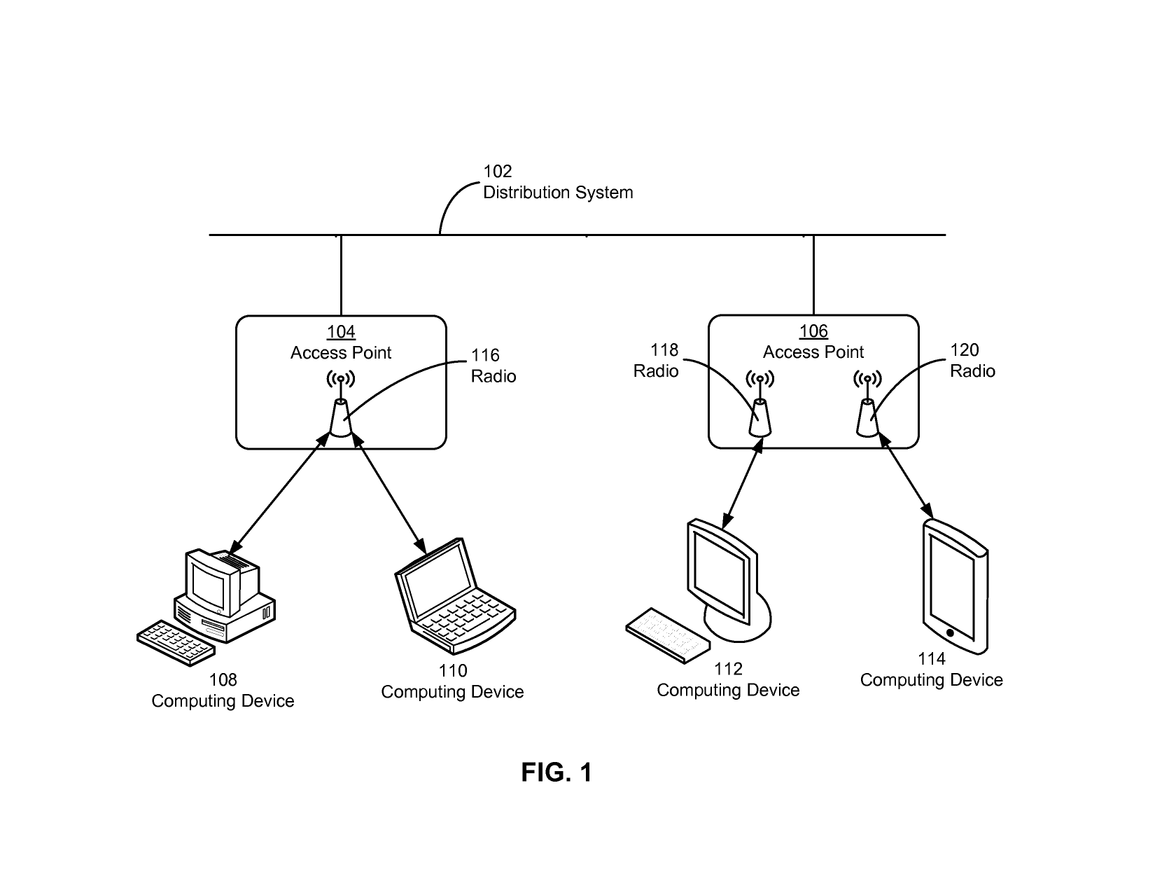

The disclosed embodiments provide a method and system for facilitating communication between computing devices such as personal computers, laptop computers, tablet computers, mobile phones, portable media players, digital cameras, digital media receivers, and/or other network-enabled electronic devices. As shown in FIG. 1, a set of computing devices 108-114 are connected to a distribution system 102 of a wireless local area network (WLAN) through a set of access points 104-106. For example, computing devices 108-114 and access points 104-106 may form an extended service set (ESS) of an 802.11 wireless network.

In particular, computing devices 108-110 are connected to one access point 104 of distribution system 102, and computing devices 112-114 are connected to a different access point 106 of distribution system 102. In addition, computing devices 108-110 are connected to a single radio 116 of access point 104, while computing devices 112-114 are connected to two different radios 118-120 (e.g., 2.4-GHz radio, 5-GHz radio) of access point 106. As a result, computing devices 108-110, radio 116, and access point 104 may form a basic service set (BSS) within distribution system 102, while computing devices 112-114 may reside on different BSSes associated with different radios 118-120 of a single access point 106.

Computing devices 108-114 may communicate with one another and/or with other computing devices through distribution system 102. For example, computing devices 108-114 may use access points 104-106 and/or distribution system 102 to transfer files, stream audio and/or video, and/or share desktops and/or user interfaces (UIs) among one another. However, communication among computing devices 108-114 may be limited by the availability, bandwidth, and/or capabilities of access points 104-106 and/or distribution system 102.

Alternatively, computing devices on the same BSS of distribution system 102 may use direct links to communicate with one another. For example, computing devices 108-110 may both advertise support for the Tunneled Direct Link Setup (TDLS) feature as defined by the 802.11-2012 standard. Once computing device 108 detects the presence of network traffic to and from computing device 110 through access point 104 and radio 116, computing device 108 may send a discovery request to computing device 110 to assess the signal strength and capabilities between the two computing devices 108-110. If the signal strength and/or capabilities (e.g., supported data rates, channel bandwidth, frame aggregation, etc.) between computing devices 108-110 are better than the signal strength and/or capabilities through access point 104, computing device 108 may send a setup request for a TDLS direct link to computing device 110, and computing device 110 may reply with a positive response. Computing device 108 may then send a confirmation of the direct link setup to computing device 110, and computing devices 108-110 may begin transmitting network traffic to one another through the direct link. In turn, communication over the direct link may improve throughput between computing devices 108-110 and/or utilize wireless networking capabilities (e.g., bandwidth, etc.) shared by computing devices 108-110 but lacking in access point 104.

However, the 802.11-2012 standard may not support the setting up of direct links between computing devices that are not on the same BSS. For example, computing devices 110-114 may belong to three different BSSes and thus be incapable of establishing TDLS direct links with one another. Instead, communication among computing devices 110-114 may be limited to and by distribution system 102 and/or other structured networks in proximity to computing devices 110-114.

In one or more embodiments, computing devices 108-114 include functionality to establish direct links with one another on an ESS of distribution system 102. As discussed in further detail below, a first computing device (e.g., computing devices 108-114) may obtain connection information associated with a second computing device (e.g., computing devices 108-114) connected to the first computing device through an ESS (e.g., access points 104-106) of a WLAN (e.g., distribution system 102). The connection information may be obtained by sending one or more requests associated with the direct link to the second computing device and obtaining one or more responses to the request(s) from the second computing device. The connection information may then be obtained from the response(s).

Next, the first computing device may use the connection information to move the first computing device from a first BSS associated with the first computing device to a second BSS associated with the second computing device. Once the first computing device is connected to the second BSS, the first computing device may establish a direct link with the second computing device, and network traffic between the two computing devices may be transmitted over the direct link, thus bypassing the use of access points 104-106 and/or distribution system 102 in transmitting the network traffic.

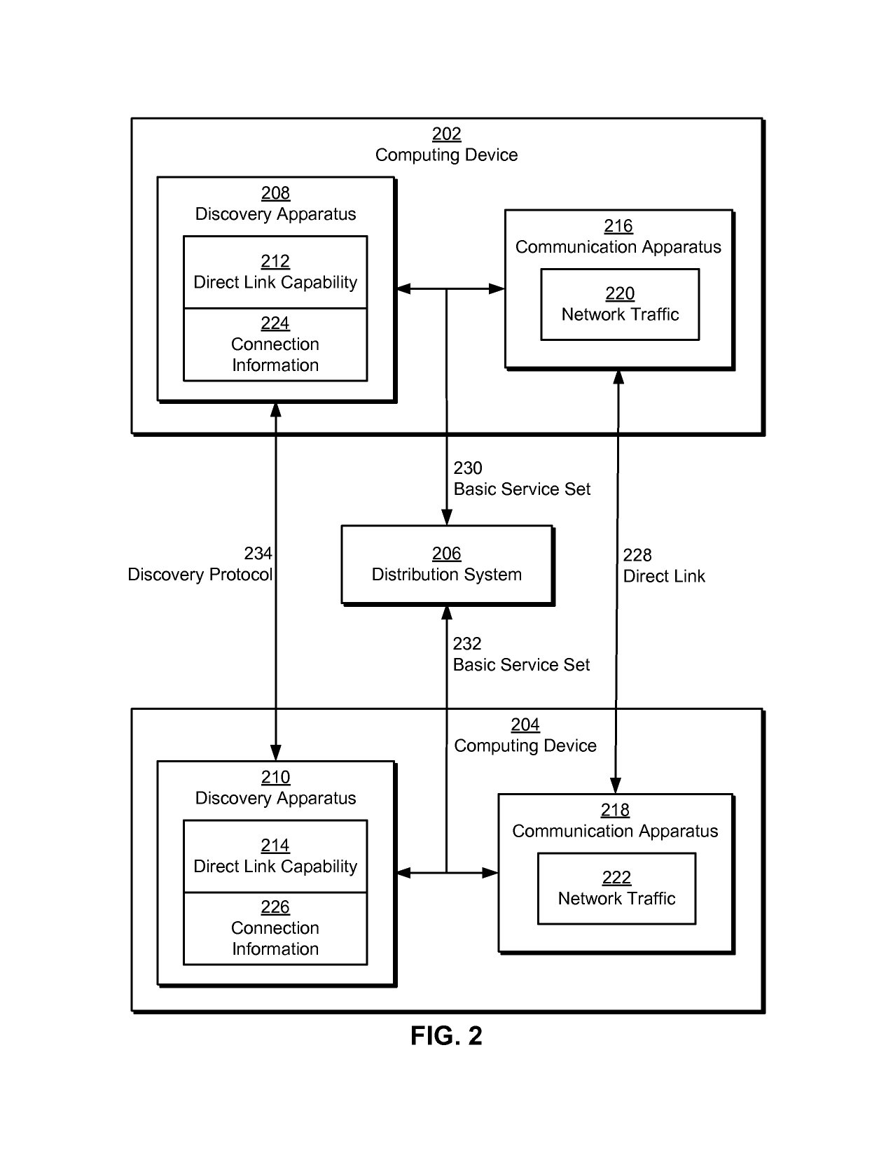

FIG. 2 shows a system for facilitating communication between a set of computing devices 202-204 connected to one another through a distribution system 206 of a WLAN (e.g., the WLAN of FIG. 1). Computing devices 202-204 may initially communicate with one another through distribution system 206 of the WLAN. In addition, computing device 202 may be on one BSS 230 of the ESS, and computing device 204 may be on a different BSS 232 of the ESS. As a result, computing devices 202-204 may not be able to establish a direct link 228 (e.g., TDLS direct link) using mechanisms defined in the 802.11-2012 standard, even if both computing devices 202-204 are TDLS-capable.

Instead, network traffic 220-222 between computing devices 202-204 may be transmitted by a communication apparatus 216-218 (e.g., wireless card, modem, etc.) on a first computing device from computing devices 202-204 over a first BSS 230-232 of the first computing device. The network traffic may then be transmitted along distribution system 206 until the network traffic is sent over a second BSS 230-232 of a second computing device from computing devices 202-204 to the communication apparatus of the second computing device. Transmission of the network traffic may thus be limited by the bandwidth, throughput, signal strengths, and/or other capabilities of distribution system 206 and/or other components of the WLAN.

To enable the creation of direct link 228 and facilitate communication between computing devices 202-204, a discovery apparatus 208-210 on the first computing device may obtain connection information 224-226 associated with the second computing device. The connection information may describe the network components and/or features used by the second computing device to connect to the WLAN, the first computing device, and/or other computing devices on the WLAN.

In particular, the connection information may include a direct link status indicating the enabling or disabling of a direct link capability (e.g., direct link capabilities 212-214) on the second computing device and an extended service set identifier (ESSID) (e.g., a network name for the ESS) associated with the second computing device. The connection information may also include a basic service set identifier (BSSID) (e.g., Media Access Control (MAC) address of the access point to which the second computing device is connected), a current operating channel (e.g., of the radio to which the second computing device is connected), and supported bands of the computing device (e.g., 2.4 GHz, 5 GHz, etc.). Finally, the connection information may include a signal strength (e.g., received signal strength indication (RSSI)) and a security mode (e.g., Wired Equivalent Privacy (WEP), WiFi Protected Access (WPA), WPA2-Personal, WPA2-Enterprise, etc.).

To obtain the connection information, the discovery apparatus may transmit one or more requests associated with direct link 228 to the second computing device and obtain one or more responses to the request(s) from a corresponding discovery apparatus on the second computing device. The discovery apparatus may then obtain the connection information from the response(s).

In one or more embodiments, the request(s) transmitted from the first computing device to the second computing device include a discovery request and/or a first setup request for direct link 228. The discovery request may be made using a discovery protocol 234 such as Bonjour (Bonjour™ is a registered trademark of Apple Inc.). For example, the first computing device may make a Bonjour discovery request for all direct link capabilities 212-214 of nearby computing devices. The second computing device may return one or more Bonjour records confirming the direct link capability and containing some or all of the connection information.

Alternatively, if one or both computing devices do not implement discovery protocol 234, the first computing device may send a first setup request for direct link 228 to the second computing device. For example, the first computing device may transmit the first setup request as a TDLS setup request to the second computing device. Because the two computing devices are on different BSSes, the second computing device may transmit a negative response declining the TDLS setup request, with the connection information included in one or more information elements of the negative response.

The first computing device may additionally perform the first setup request independently of the discovery request to initiate a handshake associated with establishing direct link 228 on the BSS of the second computing device. The second computing device may complete the handshake by replying with the negative response, with or without the connection information. The handshake may prevent the two computing devices from subsequently failing to establish direct link 228 by continually roaming to one another's BSSes.

Next, the first computing device may use the connection information to move from a first BSS of the first computing device to a second BSS of the second computing device. For example, the communication apparatus on the first computing device may obtain the connection information from the discovery apparatus and perform another discovery request on the channel provided in the connection information to assess the signal strength between the computing devices. Alternatively, the communication apparatus may obtain the signal strength from the discovery response to the first discovery request and/or from the negative response to the first setup request if, for example, the second computing device does not implement discovery protocol 234.

If the signal strength indicates no signal or a weak signal between the computing devices and/or no signal or a weak signal between the first computing device and the second BSS, the communication apparatus may not initiate direct link 228. On the other hand, if the signal strength between the computing devices is sufficiently strong, the first computing device may establish direct link 228 with the second computing device. In particular, the first computing device may transmit a second setup request for direct link 228 to the second computing device. Because the first and second computing devices are now on the same BSS, the second computing device may transmit a positive response to the second setup request, thereby establishing direct link 228. Network traffic 220-222 may then be transmitted between the two computing devices over direct link 228.

Upon detecting that network traffic 220-222 and/or the RSSI between the computing devices have fallen below a pre-specified threshold, the communication apparatus may terminate direct link 228. For example, the communication apparatus may transmit a teardown message to the second computing device to end the transmission of network traffic between the two computing devices over direct link 228. The communication apparatus may then move the first computing device from the second BSS back to the first BSS if the first BSS is associated with a more robust connection (e.g., higher signal strength, more bandwidth, cleaner signal, etc.) than the second BSS.

By enabling direct links between computing devices (e.g., computing devices 202-204) on the same ESS but on different BSSes, the system of FIG. 2 may reduce the number of hops and, in turn, improve the throughput of network traffic 220-222 between the computing devices. Moreover, the system of FIG. 2 may facilitate the optimal transmission of network traffic 220-222 by routing network traffic 220-222 through BSSes 230-232 and/or direct link 228 based on signal strengths, bandwidths, and/or other capabilities of nodes (e.g., computing devices 202-204, distribution system 206) associated with BSSes 230-232 and/or direct link 228.

Those skilled in the art will appreciate that the system of FIG. 2 may be implemented in a variety of ways. For example, the discovery apparatus (e.g., discovery apparatuses 208-210) and communication apparatus (e.g., communication apparatuses 216-218) of each computing device (e.g., computing devices 202-204) may be provided by the same software and/or hardware component, or the discovery apparatus and communication apparatus may execute independently from one another. Similarly, as described above, computing devices 202-204 may communicate direct link capabilities 212-214 and connection information 224-226 in a number of ways, including different types and combinations of requests (e.g., discovery requests, setup requests) and responses to one another.

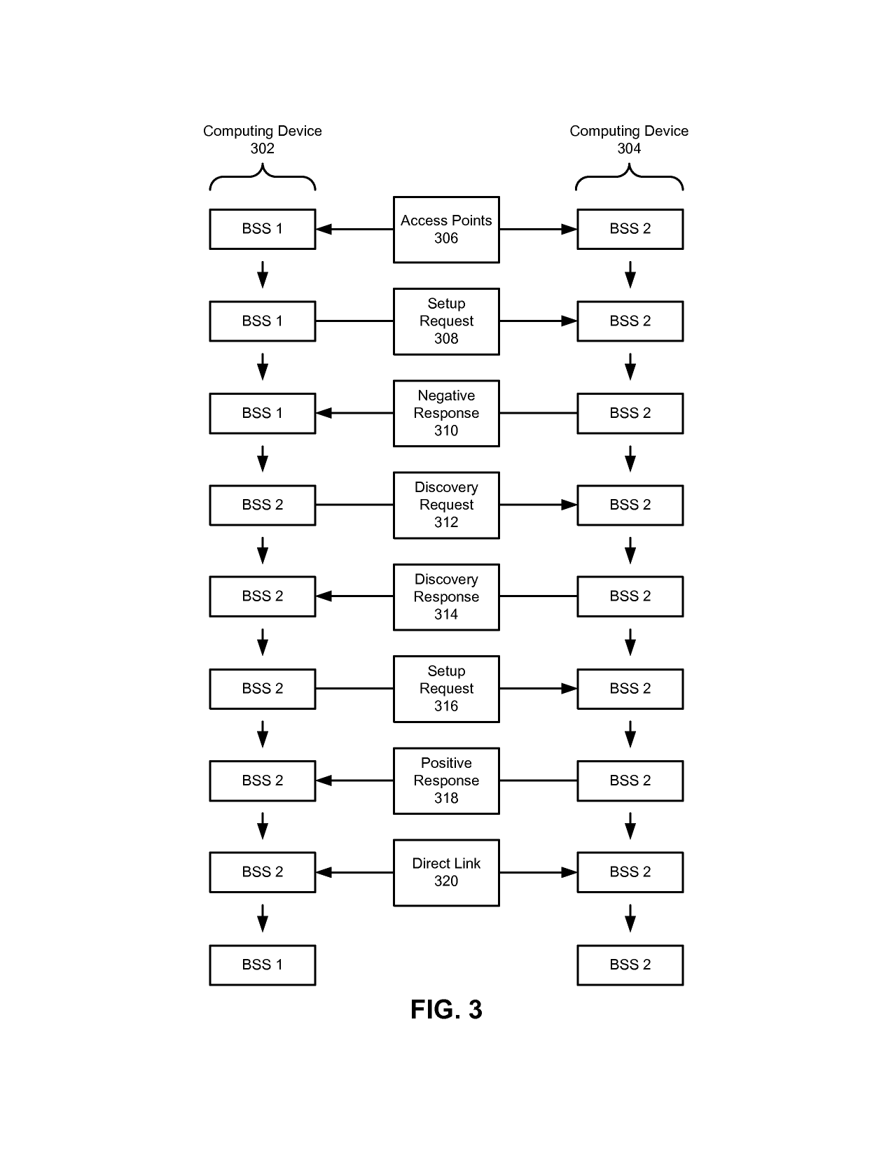

FIG. 3 shows the exemplary operation of two computing devices 302-304 on an ESS of a WLAN in accordance with the disclosed embodiments. The computing devices may begin with a first computing device 302 on a first BSS (e.g., “BSS 1”), a second computing device 304 on a second BSS (e.g., “BSS 2”), and network traffic between computing devices 302-304 routed through access points 306 associated with the first and second BSSes.

One or both computing devices 302-304 may also be aware of direct link capabilities on the other computing device. For example, one or both computing devices 302-304 may have access to Bonjour records associated with the direct link capability on the other computing device. The Bonjour records may additionally contain connection information associated with the other computing device, including a direct link status, an ESSID, a BSSID, a current operating channel, supported bands, supported channels, a signal strength, and/or a security mode for the other computing device and/or the network to which the other computing device is connected.

On the other hand, if one or both computing devices 302-304 do not implement Bonjour and/or another discovery protocol, computing device 302 may send a setup request 308 for the direct link to computing device 304, and computing device 304 may reply with a negative response 310 containing the connection information (e.g., in one or more information elements). Even if computing device 302 already has connection information for computing device 304 (e.g., through the discovery protocol), setup request 308 and negative response 310 may still be exchanged to perform a handshake associated with establishing the direct link on the second BSS. The handshake may prevent computing devices 302-304 from “missing” each other during continual attempts to send setup requests on each other's operating channels.

Next, computing device 302 may use the connection information to move from the first BSS to the second BSS. For example, computing device 302 may use the connection information to move from a first band (e.g., 5 GHz) associated with the first BSS to a second band (e.g., 2.4 GHz) associated with the second BSS if computing device 302 has dual-band capabilities and computing device 304 supports only the second band. Once computing device 302 is on the second BSS, computing device 302 may send a discovery request 312 to computing device 304 and receive a discovery response 314 from computing device 304. Computing device 302 may then use the received signal strength indication (e.g., an RSSI) from discovery response 314 to determine if the direct link should be set up. Alternatively, computing device 302 may obtain the received signal strength from negative response 310 if computing device 304 does not implement the discovery protocol associated with discovery request 312.

After computing device 302 determines that the signal strength does not indicate a weak signal between computing devices 302-304, computing device 302 may send a second setup request 316 for the direct link to computing device 304, and computing device 304 may send a positive response 318 back to computing device 302. After the direct link 320 is established, network traffic may then be transmitted over the direct link 320 until the network traffic has effectively completed. Once the network traffic falls below a pre-specified threshold, the direct link is terminated by computing device 302 (e.g., by transmitting a teardown message to computing device 304). Finally, computing device 302 may move back to the first BSS if the first BSS is associated with a more robust connection than the second BSS and/or if a change in the robustness of the BSS connection of either computing device 302-304 passes a pre-specified threshold.

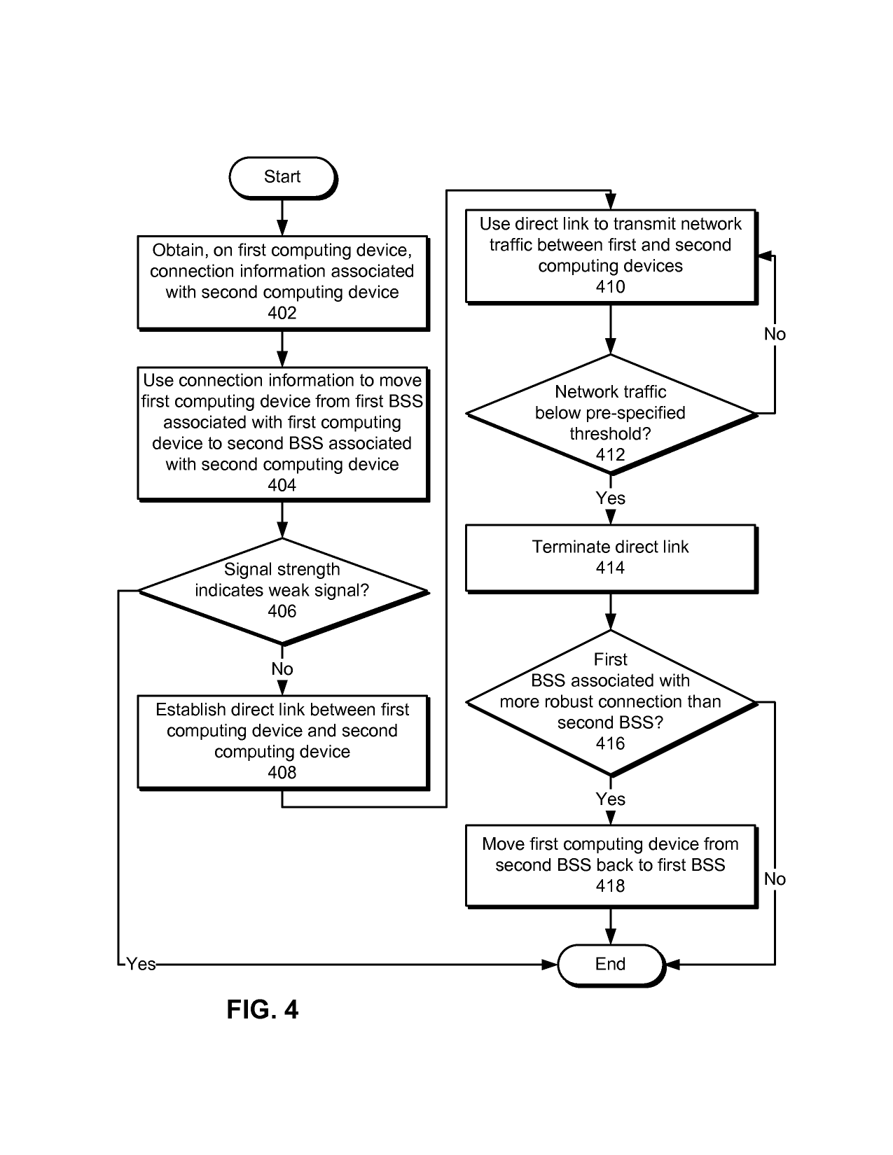

FIG. 4 shows a flowchart illustrating the process of facilitating communication between a first computing device and a second computing device connected to the first computing device through an ESS of a WLAN in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, connection information associated with the second computing device is obtained on the first computing device (operation 402). The connection information may include a direct link status, an ESSID (e.g., of the ESS), a BSSID, a current operating channel, supported bands, supported channels, supported channel bandwidths, a signal strength, and/or a security mode. The first computing device may obtain the connection information by transmitting one or more requests associated with the direct link to the second computing device and obtaining one or more responses to the one or more requests from the second computing device. For example, the first computing device may transmit a discovery request and/or a first setup request for the direct link to the second computing device and obtain a discovery response and/or a negative response to the first setup request from the second computing device. The first computing device may then obtain the connection information from the discovery response and/or one or more information elements of the negative response.

Next, the connection information is used to move the first computing device from a first BSS associated with the first computing device to a second BSS associated with the second computing device (operation 404). For example, the first computing device may use the connection information to “roam” to the BSSID and current operating channel of the second operating device.

The signal strength from the connection information may indicate a weak signal (operation 406) between the first and second computing devices. As mentioned above, the signal strength may be obtained prior to moving the first computing device to the second BSS, or the signal strength may be obtained in a discovery request after the first computing device is connected to the second BSS. If the signal strength indicates a weak signal between the first and second computing devices, the direct link is not initiated.

If the signal strength indicates a sufficiently strong signal between the first and second computing devices, the direct link is established between the first computing device and the second computing device (operation 408). For example, the first computing device may establish the direct link by transmitting a second setup request for the direct link to the second computing device and receiving a positive response to the second setup request from the second computing device. The direct link is then used to transmit network traffic between the first and second computing devices (operation 410), thus improving throughput and enabling the use of capabilities shared by the computing devices but lacking in the first and/or second BSSes.

The network traffic may fall below a pre-specified threshold (operation 412) after transmission of the network traffic is effectively complete. If the network traffic has not fallen below the threshold, transmission of the network traffic over the direct link may continue (operation 410). Once the network traffic is detected to have fallen below the threshold, the direct link is terminated (operation 414). For example, the first computing device may terminate the direct link by transmitting a teardown message for the direct link to the second computing device.

The first BSS may also be associated with a more robust connection than the second BSS (operation 416). If the first BSS is not associated with a more robust connection than the second BSS, the first computing device may remain on the second BSS after the direct link is terminated. Conversely, if the first BSS is associated with a more robust connection than the second BSS, the first computing device is moved from the second BSS back to the first BSS (operation 418) to facilitate subsequent communication between the first computing device and other computing devices.

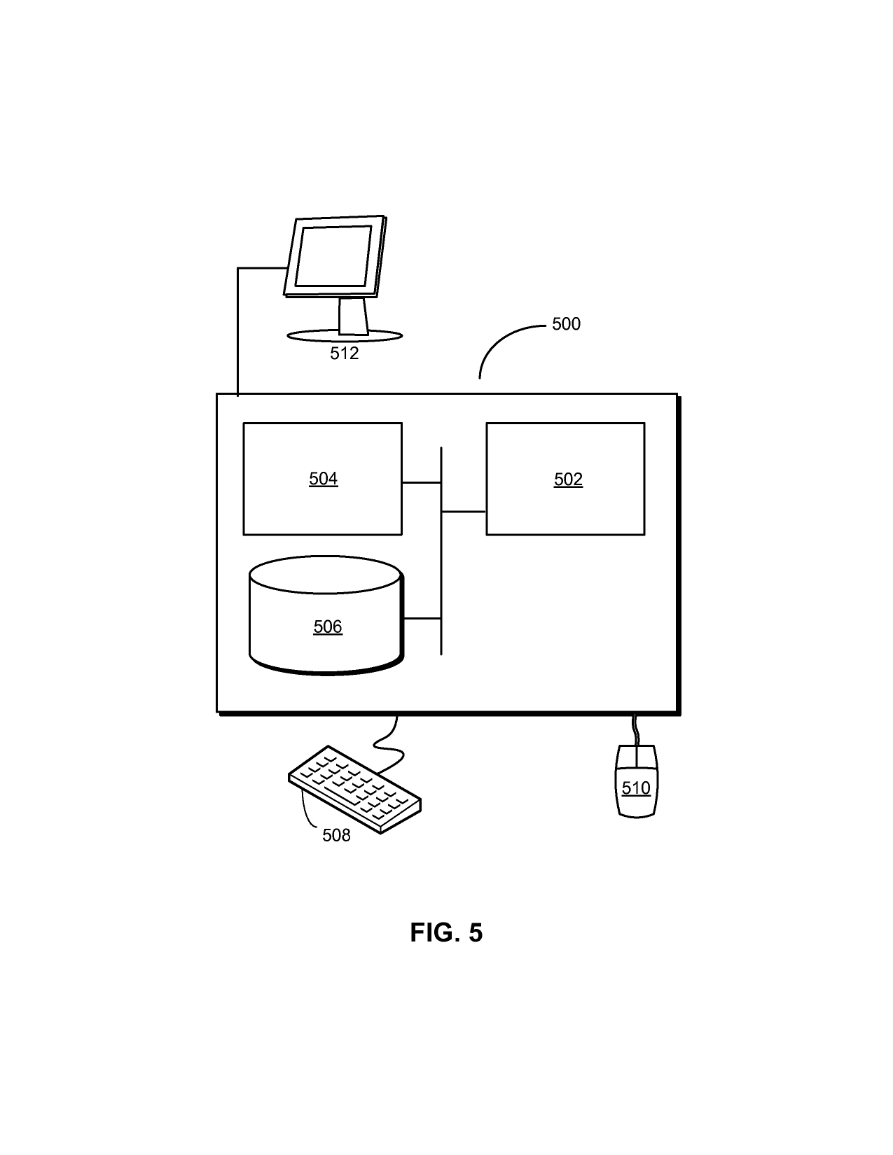

FIG. 5 shows a computer system 500 in accordance with the disclosed embodiments. Computer system 500 may correspond to an apparatus that includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for facilitating communication between a first computing device and a second computing device connected to the first computing device through an ESS of a WLAN. The system may include a discovery apparatus that obtains connection information associated with the second computing device. The system may also include a communication apparatus that uses the connection information to move the first computing device from a first BSS associated with the first computing device to a second BSS associated with the second computing device. After the first computing device is connected to the second BSS, the communication apparatus may establish a direct link between the first computing device and the second computing device, thus facilitating subsequent communication between the first and second computing devices. If network traffic over the direct link falls below a pre-specified threshold, the communication apparatus may terminate the direct link. Finally, once the direct link is terminated, the communication apparatus may move the first computing device from the second BSS back to the first BSS if the first BSS is associated with a more robust connection than the second BSS.

In addition, one or more components of computer system 500 may be remotely located and connected to the other components over a network. Portions of the present embodiments (e.g., discovery apparatus, communication apparatus, computing devices, etc.) may also be located on different nodes of a distributed system that implements the embodiments. For example, the present embodiments may be implemented using a number of computing devices connected through an ESS of a WLAN and/or one or more direct links with one another.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for facilitating communication between a first computing device and a second computing device connected to the first computing device through an extended service set (ESS) of a wireless local area network (WLAN), comprising:
obtaining, on the first computing device, connection information associated with the second computing device;
using the connection information to move the first computing device from a first basic service set (BSS) associated with the first computing device to a second BSS associated with the second computing device; and
after the first computing device is connected to the second BSS, establishing a direct link between the first computing device and the second computing device, wherein the direct link facilitates subsequent communication between the first and second computing devices.

2. The computer-implemented method of claim 1, further comprising:
if network traffic over the direct link falls below a pre-specified threshold:
terminating the direct link; and
if the first BSS is associated with a more robust connection than the second BSS, moving the first computing device from the second BSS back to the first BSS.

3. The computer-implemented method of claim 1, wherein obtaining the connection information associated with the second computing device involves:
transmitting one or more requests associated with the direct link from the first computing device to the second computing device; and
obtaining one or more responses to the one or more requests from the second computing device, wherein the one or more responses comprise the connection information.

4. The computer-implemented method of claim 3, wherein the one or more requests comprise at least one of:
a discovery request; and
a first setup request for the direct link.

5. The computer-implemented method of claim 4,
wherein the first setup request is made by the first computing device on the first BSS, and
wherein the first setup request is associated with a negative response from the second computing device.

6. The computer-implemented method of claim 5, wherein the first setup request and the negative response comprise a handshake associated with establishing the direct link on the second BSS.

7. The computer-implemented method of claim 5, wherein establishing the direct link between the first computing device and the second computing device involves:
transmitting a second setup request for the direct link from the first computing device to the second computing device; and
receiving a positive response to the second setup request from the second computing device.

8. The computer-implemented method of claim 1, wherein the connection information comprises at least one of:
a direct link status;
a extended service set identifier (ESSID);
a basic service set identifier (BSSID);
a current operating channel;
supported bands;
supported channels;
a signal strength; and
a security mode.

9. The computer-implemented method of claim 8, wherein the direct link is not initiated if the signal strength indicates a weak signal between the first and second computing devices.

10. A system for facilitating communication between a first computing device and a second computing device connected to the first computing device through an extended service set (ESS) of a wireless local area network (WLAN), comprising:
a discovery apparatus configured to obtain connection information associated with the second computing device; and
a communication apparatus configured to:
use the connection information to move the first computing device from a first basic service set (BSS) associated with the first computing device to a second BSS associated with the second computing device; and
after the first computing device is connected to the second BSS, establish a direct link between the first computing device and the second computing device, wherein the direct link facilitates subsequent communication between the first and second computing devices.

11. The system of claim 10, wherein if network traffic over the direct link falls below a pre-specified threshold, the communication apparatus is further configured to:
terminate the direct link; and
if the first BSS is associated with a more robust connection than the second BSS, move the first computing device from the second BSS back to the first BSS.

12. The system of claim 10, wherein obtaining the connection information associated with the second computing device involves:
transmitting one or more requests associated with the direct link from the first computing device to the second computing device; and
obtaining one or more responses to the one or more requests from the second computing device, wherein the one or more responses comprise the connection information.

13. The system of claim 12, wherein the one or more requests comprise at least one of:
a discovery request; and
a first setup request for the direct link.

14. The system of claim 13,
wherein the first setup request is made by the first computing device on the first BSS, and
wherein the first setup request is associated with a negative response from the second computing device.

15. The system of claim 14, wherein the first setup request and the negative response comprise a handshake associated with establishing the direct link on the second BSS.

16. The system of claim 14, wherein establishing the direct link between the first computing device and the second computing device involves:
transmitting a second setup request for the direct link from the first computing device to the second computing device; and
receiving a positive response to the second setup request from the second computing device.

17. The system of claim 10, wherein the connection information comprises at least one of:
a direct link status;
a extended service set identifier (ESSID);
a basic service set identifier (BSSID);
a current operating channel;
supported bands;
supported channels;
a signal strength; and
a security mode.

18. A computer-readable storage medium storing instructions that when executed by a computer cause the computer to perform a method for facilitating communication between a first computing device and a second computing device connected to the first computing device through an extended service set (ESS) of a wireless local area network (WLAN), the method comprising:
obtaining, on the first computing device, connection information associated with the second computing device;
using the connection information to move the first computing device from a first basic service set (BSS) associated with the first computing device to a second BSS associated with the second computing device; and
after the first computing device is connected to the second BSS, establishing a direct link between the first computing device and the second computing device, wherein the direct link facilitates subsequent communication between the first and second computing devices.

19. The computer-readable storage medium of claim 18, the method further comprising:
if network traffic over the direct link falls below a pre-specified threshold:
terminating the direct link; and
if the first BSS is associated with a more robust connection than the second BSS, moving the first computing device from the second BSS back to the first BSS.

20. The computer-readable storage medium of claim 18, wherein obtaining the connection information associated with the second computing device involves:
transmitting one or more requests associated with the direct link from the first computing device to the second computing device; and
obtaining one or more responses to the one or more requests from the second computing device, wherein the one or more responses comprise the connection information.

21. The computer-readable storage medium of claim 20, wherein the one or more requests comprise at least one of:
a discovery request; and
a first setup request for the direct link.

22. The computer-readable storage medium of claim 21,
wherein the first setup request is made by the first computing device on the first BSS, and
wherein the first setup request is associated with a negative response from the second computing device.

23. The computer-readable storage medium of claim 22, wherein the first setup request and the negative response comprise a handshake associated with establishing the direct link on the second BSS.

24. The computer-readable storage medium of claim 22, wherein establishing the direct link between the first computing device and the second computing device involves:
transmitting a second setup request for the direct link from the first computing device to the second computing device; and
receiving a positive response to the second setup request from the second computing device.

25. The computer-readable storage medium of claim 18, wherein the connection information comprises at least one of:
a direct link status;
a extended service set identifier (ESSID);
a basic service set identifier (BSSID);
a current operating channel;
supported bands;
supported channels;
a signal strength; and
a security mode.
